(19) United States
(12) Patent Application Publication
(10) Pub. No.: US 2011/0036947 A1
(43) Pub. Date: Feb. 17, 2011

(54) COATING SYSTEM FOR AIRCRAFT AND AIRCRAFT COATED THEREWITH

(75) Inventor: Michael C. Knight, McHenry, IL (US)

Correspondence Address: HEXION SPECIALTY CHEMICALS, INC., 12650 Directors Drive, Suite 100, Stafford, TX, 77477, US

(73) Assignee: Hexion Specialty Chemicals, Inc.

(21) Appl. No.: 12/542,034

(22) Filed: Aug. 17, 2009

(51) Int. Cl. B64C 1/00; B05D 3/02

(52) U.S. Cl. 244/130; 427/385.5

(57) ABSTRACT

An aircraft having aerodynamic surfaces coated with a clear coat may be more easily cleaned and be more resistant to solvent degradation to the aircraft's paint. Such a clear coat is one having been prepared using a resin formulation including an aliphatic methacrylate and a curing agent, wherein the clear coat passes the SKYDROL Test.

### BACKGROUND OF THE INVENTION

1. Field of the Invention

The invention relates to a coating system. The invention particularly relates to a coating system for use on the exterior of aircraft.

2. Background of the Disclosure

Painted aerodynamic surfaces of an aircraft, both during flight and while on the ground, may be subjected to conditions that result in damage to the paint. These conditions may include insect impacts during low altitude operation (i.e., during take-off and landing); scratches from projectile impacts during flight, and even scuffs and scratches occurring during maintenance. Any of these may be very undesirable for a number of reasons.

For example, insects sticking to the aerodynamic surfaces may result in performance degradation such as increased aircraft drag and boundary layer transition from laminar to turbulent airflow. The acids and other chemicals from insect strikes are sometimes corrosive to paint. Scratches and scuffs and chips in the paint of an aircraft may result in performance degradation and also a poor aesthetic appearance. Particularly for a commercial air carrier, it would be desirable that their aircraft have a pleasing aesthetic appearance.

### SUMMARY OF THE DISCLOSURE

In one aspect, the invention is an aircraft having aerodynamic surfaces coated with a clear coat, the clear coat having been prepared using a resin formulation including an aliphatic methacrylate and an isocyanurate, wherein the coating has a Tg of from about 50 to about 100° C., the resin has an OH number of from about 130 to about 230, and the clear coat passes the SKYDROL Test.

In another aspect, the invention is a process of coating an aircraft's aerodynamic surfaces with a coating wherein the coating is a clear coat, the clear coat having been prepared using a resin formulation including an aliphatic methacrylate and an isocyanurate, wherein the coating has a Tg of about 50 to about 100° C., the resin has an OH number of from about 130 to about 230, and the clear coat passes the SKYDROL test.

### BRIEF DESCRIPTION OF THE DRAWINGS

The advantages and further aspects of the disclosure will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a schematic representation of a coating system of the application applied to a surface of an aircraft having present a basecoat; and

FIG. 2 is a schematic representation of a coating system of the application applied directly to a surface of an aircraft.

### DETAILED DESCRIPTION OF THE DISCLOSURE

In one aspect, the invention is an aircraft having aerodynamic surfaces coated with a clear coat. A clear coat finish is an element of a multi-layer paint system including an optional primer, a base coat of a pigmented paint, and a clear coat at the surface of a painted object. The clear coat may function to protect the base coat from oxidation using ultraviolet absorbers to mitigate ultraviolet light exposure. It also may mechanically protect the base coat from scratches and abrasions. The claimed clear coat may also serve to protect the base coat from chemical attack, especially from solvent like compounds such as hydraulic fluids and fuels.

One advantage of the coating systems of the disclosure is a weight savings over conventional painting. Since the coating system includes a clear coat, the advantages of a clear coat, namely a lower base coat thickness requirement, is present in at least some embodiments of the invention.

The clear coat of the coating systems of the application has a decided advantage of being “buffable.” For the purposes of the application, the term buffable means that the clear coat may be lightly sanded and then buffed back to “like new” using conventional buffing techniques currently used within the automobile industry. The ability to use the automotive buffing technology in an aviation application allows for both a cost and downtime savings. Downtime of aircraft may be very undesirable due to the high cost of the aircraft which may be many millions of dollars.

The clear coats of the disclosure may be prepared using an aliphatic methacrylate resin. Such resins may be prepared using one or more monomers having a general formula:

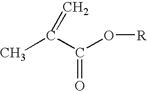

wherein R is a branched, cyclic or bicyclic aliphatic group having from about 4 to about 15 carbons. For example, t-butyl methacrylate, isobornyl methacrylate and cylcohexyl methacrylate may be used to prepare the aliphatic methacrylate resin. More than a single such monomer may be used to prepare the resins.

The aliphatic methacrylate resin may be prepared with at least one additional monomer capable of imparting hydroxyl functionality to the resin sufficient to allow it to be cured using an isocyanurate. Examples of monomers useful for imparting the hydroxyl functionality include but are not limited to: 2-hydroxyethyl acrylate, 2-hydroxyethyl methacrylate, 2-hydroxypropyl acrylate, 2-hydroxypropyl methacrylate, 4-hydroxybutyl methacrylate, tetraethylene glycol acrylate, para-vinylbenzyl alcohol and the like.

Such resins may be prepared by admixing the monomers with an initiator to promote polymerization through the unsaturation of the monomers. Any initiator known to be useful may be used. For example, in some embodiments, suitable initiators include common peroxy compounds or azo compounds. Suitable peroxides include, for example, alkali metal peroxodisulfates, for example sodium peroxodisulfate, ammonium peroxodisulfate; hydrogen peroxide; organic peroxides, for example diacetyl peroxide, di-tert-butyl peroxide, diamylperoxide, dioctanoyl peroxide, didecanoyl peroxide, dilauroyl peroxide, dibenzol peroxide, bis-(o-toloyl)peroxide, succinyl peroxide, tert-butyl peracetate, tert-butyl permaleinate, tert-butyl perpivalate, tert-butylperoctoate, tert-butyl pemeodecanoate, tert-butyl perbenzoate, tert-butyl peroxide, tert-butyl hydroperoxide, cumene hydroperoxide, tert-butyl-peroxy-2-ethylhexanoate, and diisopropyl peroxodicarbamate. Suitable azo compounds include, for example azobis isobutyronitrile, anzobis(2-amidopropane)dihydrochloride, and 2,2[prime]-azobis(2-methylbutyronitrile).

The acrylic resin useful with the coatings of the disclosure may have an OH number of from about 130 to about 230. In some embodiments, the OH number of the acrylic resin may be from about 140 to about 200. In other embodiments, the OH number maybe about 160.

The resins used to prepare the clear coats of the application may include, in addition to the monomers already discussed, a polyester polyol resin. The polyester polyol resins may be prepared by any means known to be useful to those of ordinary skill in the art, but generally may be formed by the esterification of a polyol with a polycarboxylic acid or an acid anhydride.

Polyols that may be useful in making the polyester polyol resin include, but are not limited to alkylene glycols, such as ethylene glycol, propylene glycol, butylene glycol and neopentyl glycol, and other glycols such as hydrogenated bisphenol A, cyclohexane dimethanol, caprolactonediol reaction products, hydroxy alkylated bisphenols, polyether glycols, e.g., poly(oxytetramethylene) glycol and similar type compounds. Other diols of various types and polyols of higher functionality can also be used. Such higher polyols include trimethylolpropane, trimethylolethane, pentaerythritol and higher molecular weight polyols such as obtained by reaction of ethylene oxide and trimethylolpropane and various hydrolyzed epoxy resins.

Carboxylic acids which may be used to prepare polyester polyol resins include, but are not limited to phthalic acid, isophthalic acid, terephthalic acid, tetrahydrophthalic acid, hexahydrophthalic acid, adipic acid, azelaic acid, sebacic acid, glutaric acid, chlorendic acid, tetrachlorophthalic acid, maleic acid, fumaric acid, itaconic acid, malonic acid, suberic acid, trimellitic acid, and anhydrides of these acids where they exist. These polyester polyol resins are well known in the art and may be prepared according to the method disclosed in U.S. Pat. No. 4,892,906 to Pham, et al. which is hereby fully incorporated herein by reference.

As stated, the coating systems of the application may include a curing agent and the curing agent may be an isocyanurate or other compound capable of reacting with a hydroxyl group to form a cross-link. These trifunctional or higher functionality compounds may be prepared from aliphatic or cycloaliphatic isocyanates having at least two isocyanate groups per molecule. For example, the isocyanurates useful as curing agents with embodiments of the invention may be prepared with di- or polyisocyanates selected from the group consisting of HMDI (hydrogenated methylene diphenyl diisocyanate), HTDI (hydrogenated toluene diisocyanate) hexamethylene diisocyanate, isophorone diisocyanate, and combinations thereof.

Other curing agents may also be used as long as they are at least trifunctional and are not aromatic. For example, trifunctional polyisocyanates and trifunctional derivatives of isocyanates may be used. One such derivative would be a biuret. In one embodiment of the invention, the curing agent may be a polyisocyanate with one or more isocyanurate, allophanate, biuret or uretdione structures.

In at least some embodiments, the coating systems of the disclosure may include a catalyst to promote curing of the clear coat. The curing of the clear coat may be carried out using any catalyst known to be useful to those of ordinary skill in the art. For example, in one embodiment a tin catalyst such as one selected from the group consisting of dibutyltin dilaurate (DBTDL); dibutyltin oxide; dibutyltin dichloride; dibutyltin diacetate; dibutyltin dimaleate; dibutyltin dioctoate; dibutyltin bis(2-ethylhexanoate); tin acetate; tin octoate; tin ethylhexanoate; tin laurate and so on, as well as combinations of tin catalysts, may be used. Any catalyst that may promote curing by inducing a reaction between the curing agent and active hydrogens may be used with embodiments of the invention.

The clear coats of the application, in some embodiments, may impart solvent resistance. The solvent resistance of a coating may be measured using the “SKYDROL® test.” SKYDROL is a hydraulic fluid trademarked by the Monsanto Chemical Company and later assigned to Solutia Inc. SKYDROL is marketed as being premier hydraulic fluid for use in Aerospace applications.

Briefly, the SKYDROL test includes first immersing a coated panel in SKYDROL fluid (or its military equivalent when the coating is for a military aircraft) for 30 days. The panel is then wiped dry and inspected for blistering, loss of coating adhesion or other deterioration. A pencil hardness test is conducted to measure the hardness of the coating. In this test, a squared-off nib of an “HB” hardness pencil is held at a 45° angle to the panel and is pushed along the coating for at least ¼ inch with sufficient applied force to cause a scratch or crumble the lead nib. If the nib crumbles without scratching the coating, harder pencil numbers are used sequentially until a scratch is visible. The hardness number of this pencil is the “pencil hardness number” of the coating. The SKYDROL resistance of a coating is largely dependent on the SKYDROL resistance of the carrier for the corrosion inhibitors and pigments. Pencil hardness ratings, from softest to hardness are 6B, 5B, 4B, 3B, 2B, B, HB, F, H, 2H, 3H, 4H, 5H, 6H, 7H, 8H, 9H.

The clear coat of the application passes the SKYDROL test. For the purposes of this application, a clear coat passes the SKYDROL test if, after 30 days exposure to the SKYDROL fluid, the hardness of the clear coat has changed no more than one hardness level from its original hardness. For example, if the hardness of the clear coat is F on day 1 and F on day 30, it passes the SKYDROL test. Similarly, if the hardness of the clear coat is F on day 1 and HB on day 30, it passes the SKYDROL test. On the other hand, if the clear coat has a hardness of 4H on day 1 and a hardness of H on day 30, it fails the SKYDROL test because it changed two levels rather than one or stayed the same.

The coating of the disclosure may have Tg of from about 50 to about 100° C. In some embodiments, the Tg may be from about 55 to about 80° C. In other embodiments, it may be about 60° C.

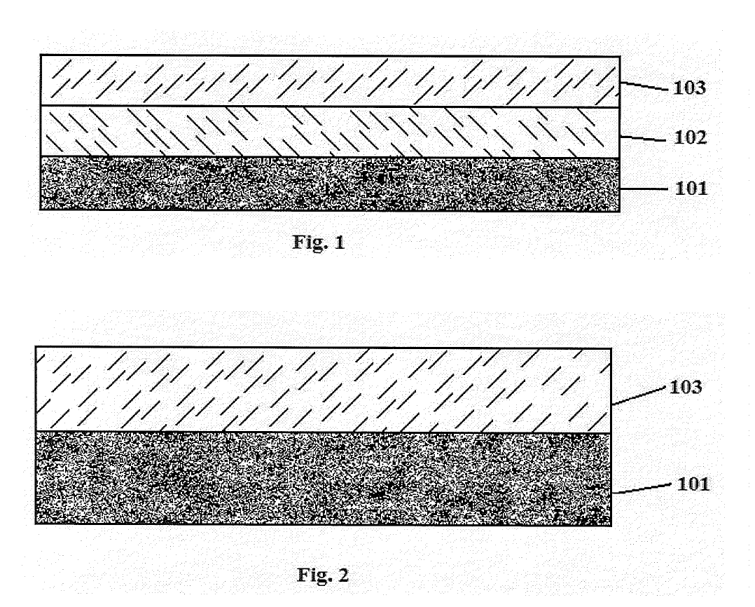

In the method of the disclosure, a clear coat is applied to an aircraft. Referring now to FIG. 1, in many embodiments, the coating system of the disclosure will include at least a substrate to be painted, namely the surface of an aircraft 101, a base coat (pigmented paint) 102, and the clear coat of the disclosure 103. Sometimes, in alternative embodiments, it may be desirable to coat an unpainted surface of an aircraft as is shown if FIG. 2.

In FIG. 2, the substrate 101 and clear coat 103 are shown in direct contact with each other. It should be noted that either of these two general types of embodiments, there may be a primer applied to the aircraft surface. This is especially true in the case of surfaces made of corrodible materials such as metal but may also be true even of surfaces that that are less subject to corrosion such as carbon fibre composites. Further, in some embodiments, it may be necessary to apply multiple coats of base coats and/or clear coats and all of these embodiments are within the scope of this disclosure.

The method of applying the coating systems of the disclosure to an airplane may be any known to be useful to those of ordinary skill in the art of painting aircraft. For example, in one embodiment, an aircraft surface may be cleaned and then primed. An air drying paint may be applied to the primed surface as a basecoat. Then a clear coat of the disclosure is applied over the basecoat.

The clear coats of the application are catalyst cured coatings. In one embodiment of the disclosure, the resins of the clear coat are admixed with a solvent and a catalyst. The admixture is then applied to the surface and the solvent is then allowed to air “dry.” Methods of coating include but are not limited to air spray coating, airless spray coating, rotary atomizing coating, curtain flow coating or the like. In some embodiments of the invention, warm air may be directed over the coated surfaces to reduce down time.

When a solvent is used it may include any solvent compatible with the resins and catalysts of the disclosure. Exemplary solvents include, but are not limited to butyl acetate, ethoxyethyl propionate, methyl isoamyl ketone and the like.

The aircraft that may be coated by the method of the application may be any aircraft, but aircraft that are large and not easily painted and/or expensive to have idled due to painting are especially suited for use of the method. For example, commercial airliners are well suited to be coated using the method of the disclosure. Military aircraft and general aviation aircraft, especially private jets, may also be coated using the method of the disclosure.

### EXAMPLES

The following examples are provided to illustrate certain embodiments of the invention. The examples are not intended to limit the scope of the application and they should not be so interpreted. Amounts are in w/v parts or w/v percentages unless otherwise indicated.

### Acrylic Polyol A

An acrylic polyol was prepared using a formulation having the following components:

| Component | Parts by Weight |
|---|---|
| Ethoxyethylpropionate (EEP) | 1000 |
| Hydroxyethyl Methacrylate | 370 |
| Butyl Acrylate | 45.6 |
| Butyl Methacrylate | 1.4 |
| Methyl Methacrylate | 266 |
| Isobutyl Methacrylate | 95 |
| Cyclohexyl Methacrylate | 266 |
| Methacrylic Acid | 4 |
| *Ethyl-3,3 Di-t-Amylperoxy Butyrate | 50 |

*available as Lupersol 533M-75 from Arkema Inc. 50

The acrylic polyol was prepared by conventional solution polymerization techniques. The EEP solvent was removed by vacuum stripping and 449 parts by weight of Methyl Amyl Ketone was added. The resultant acrylic polyol had an acid value of about 4, an OH number of about 160, a percent solids of 70.0 when measured according to ASTM 2369-07, and a viscosity of Z+½.

### Acrylic Polyol B

An acrylic polyol was prepared substantially identical to Component A except the formulation used had the following components:

| Component | Parts by Weight |
|---|---|
| Ethoxyethylpropionate (EEP) | 1000 |
| Hydroxyethyl Methacrylate | 370 |
| Butyl Acrylate | 47 |
| Methyl Methacrylate | 193 |
| Isobutyl Methacrylate | 193 |
| Isobornyl Methacrylate | 193 |
| Methacrylic Acid | 4 |
| *Ethyl-3,3 Di-t-Amylperoxy Butyrate | 50 |

*Lupersol 533M-75 from Arkema Inc.

The resultant acrylic polyol had an acid value of about 4, an OH number of about 160, a percent solids of 70.1 when measured according to ASTM 2369-07, and a viscosity of Y+½.

### Acrylic Polyol C (Comparative)

An acrylic polyol was prepared using a formulation having the following components:

| Component | Parts by Weight |
|---|---|
| Ethoxyethylpropionate (EEP) | 458 |
| **Glycidyl Neodeconoate | 423 |
| Hydroxyethyl Methacrylate | 176 |
| Butyl Acrylate | 346 |
| Styrene | 408 |
| Butyl Methacrylate | 171 |
| Methacrylic Acid | 168 |
| *Ethyl-3,3 Di-t-Amylperoxy Butyrate | 60 |

*Lupersol 533M-75 from Arkema Inc. 50
**Cardura E10 from Hexion

The acrylic polyol was prepared by conventional solution polymerization techniques. The EEP solvent was removed by vacuum stripping and 405 parts by weight of n-Butyl Acetate is added. The resultant acrylic polyol had an acid value of about 15, an OH number of about 68, a percent solids of 80 when measured according to ASTM 2369-07, and a viscosity of Z2.

### Component D

A polyester polyol was prepared using a formulation having the following components:

| Component | Parts by Weight |
|---|---|
| Hexahydrophthalic anhydride | 1552 |
| Neopentyl glycol | 801 |
| Pentaerythritol | 220.5 |
| Trimethylol propane | 589.5 |

The above ingredients were charged into a reaction vessel equipped with a stirrer, a nitrogen inlet tube, a thermometer, a steam jacket column, a fractionating column and a distillation head connected to a condenser and a receiver. The resultant mixture was heated to about 230° C. and refluxed under nitrogen. Water was continuously removed as heating was continued. The reaction mixture was held at 230° C. for about 12 hours until an acid value of between about 5 and 7 was reached. The resultant product was then cooled to about 150° C., and 990 parts by weight of Methyl Amyl Ketone was added. Analysis of the product indicated a solids content of 75 percent, a viscosity of about Z3-, an acid value of about 5.5, and a hydroxyl value of about 280.

### Component E (Comparative)

A polyester polyol was prepared substantially identical to Component D except that the reflux and reaction was at 210° C. and the following components were used:

| Component | Parts by Weight |
|---|---|
| Hexahydrophthalic anhydride | 255 |
| Neopentyl glycol | 345 |
| Butyl stannoic acid | 0.05 |
| Triphenyl phosphite | 0.5 |
| Xylene | 52.3 |

Analysis of the product indicated a solids content of 78 percent, a viscosity of about Z5-, an acid value of about 9, and a hydroxyl value of about 270.

### Examples 1-5

### Comparative Examples 6-7

A clear coating composition was prepared as following: Component A (the acrylic resin and/or polyester resin) was/were premixed with Methyl Amyl Ketone,(MAK); and then Byk 355 (flow additive from Byk Chemie), and Dibutyltin Dilaurate catalyst (DBTDL) are added and mixed. Immediately prior to spray application, Component B, a curing agent, (Desmodur N3300, a hexamethylene diisocyanate trimer) is added to Component A and mixed thoroughly. The resulting clear coat is applied at 1.5 to 1.8 mils (0.04-0.05 mm) over an aluminum substrate with commercial primer and white basecoat applied and ambient cured. Once the clear coat is applied, the coating is cured at ambient conditions prior to testing. Initial pencil hardness was measured and recorded. The coated panels were then soaked for 30 days in SKYDROL LD4. The panels were removed once a week and pencil hardness is measured and recorded. The results are displayed below in the table.

| | TABLE | | | | | | |
|---|---|---|---|---|---|---|---|
| | EXAMPLE # | | | | | | |
| | 1 | 2 | 3 | 4 | 5 | Comparative 6* | Comparative 7* |
| COMPONENT A | | | | | | | |
| ACRYLIC A | 60.7 | | 60.7 | 71.4 | | | |
| ACRYLIC B | | 60.7 | | | 71.4 | 60.7 | |
| ACRYLIC C | | | | | | | 53.1 |
| POLYESTER D | 10 | 10 | 10 | | | | 10 |
| POLYESTER E | | | | | | 9.4 | |
| MAK | 49 | 49 | 40 | 44.7 | 44.7 | 49.1 | 41.7 |
| BYK 351 | 0.26 | 0.26 | 0.26 | 0.26 | 0.26 | 0.26 | 0.26 |
| 10% DBTDL in MAK | 0.05 | 0.05 | 0.05 | 0.05 | 0.05 | 0.05 | 0.05 |
| COMPONENT B | | | | | | | |
| DESMODUR N3300 | 46 | 55.1 | 36.8 | 41.3 | 41.3 | 45.5 | 25.8 |
| SKYDROL TEST | | | | | | | |
| INITIAL | H | H | H | H | F | F | F |
| 7 DAYS | H | H | H | H | F | F | 3B |
| 15 DAYS | H | H | H | H | F | F | — |
| 22 DAYS | H | H | H | H | F | B | — |
| 30 DAYS | H | F | F | F | HB | 2B | — |
| Pass/Fail | Pass | Pass | Pass | Pass | Pass | Fail | Fail |

*Not an example of the invention

What is claimed is:

1. An aircraft having aerodynamic surfaces coated with a clear coat, the clear coat having been prepared using a resin formulation including an aliphatic methacrylate and a curing agent, wherein the coating has a Tg of from about 50 to about 100° C., the resin has an OH number of about 130 to about 230, and the clear coat passes the SKYDROL Test.

2. The aircraft of claim 1 wherein the aircraft is a commercial airliner, general aviation aircraft, or a military aircraft.

3. The aircraft of claim 1 wherein the clear coat is buffable.

4. The aircraft of claim 1 wherein the aliphatic methacrylate has a general formula: 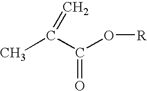
wherein R is a branched, cyclic or bicyclic aliphatic group having from about 4 to about 15 carbons.

5. The aircraft of claim 5 wherein the aliphatic methacrylate is selected from the group consisting of: t-butyl methacrylate, isobornyl methacrylate, cylcohexyl methacrylate and mixtures thereof.

6. The aircraft of claim 5 wherein the resin formulation additionally comprises an additional monomer capable of imparting hydroxyl functionality to the resin sufficient to allow it to be cured using an isocyanurate.

7. The aircraft of claim 6 wherein the additional monomer is selected from the group consisting of: 2-hydroxyethyl acrylate, 2-hydroxyethyl methacrylate, 2-hydroxypropyl acrylate, 2-hydroxypropyl methacrylate, 4-hydroxybutyl methacrylate, tetraethylene glycol acrylate, para-vinylbenzyl alcohol, and combinations thereof.

8. The aircraft of claim 1 wherein the curing agent is an isocyanurate.

9. The aircraft of claim 1 wherein the curing agent is a trifunctional compound prepared from aliphatic or cycloaliphatic isocyanates having at least two isocyanate groups per molecule.

10. The aircraft of claim 1 wherein the curing agent is a trifunctional compound prepared from di- or polyisocyanates selected from the group consisting of HMDI (hydrogenated methylene diphenyl diisocyanate), HTDI (hydrogenated toluene diisocyanate) hexamethylene diisocyanate), isophorone diisocyanate, and combinations thereof.

11. The aircraft of claim 1 wherein the curing agent has an average hydroxyl reactive functionality that is greater than 3.

12. The aircraft of claim 11 wherein the curing agent may be a polyisocyanate with one or more isocyanurate, allophanate, biuret or uretdione structures.

13. The aircraft of claim 1 wherein the acrylic resin has a OH number of from about 140 to about 200.

14. The aircraft of claim 13 wherein the acrylic resin has a OH number of about 160.

15. The aircraft of claim 1 wherein the clear coat has a Tg of from about 55 to about 80° C.

16. The aircraft of claim 15 wherein the clear coat has a Tg of about 60° C.

17. A process for coating an aircraft's aerodynamic surfaces with a coating wherein the coating is a clear coat, the clear coat having been prepared using a resin formulation including an aliphatic methacrylate and a curing agent, wherein the coating has a Tg of from about 50 to about 100° C., the resin has an OH number of about 130 to about 230, and the clear coat passes the SKYDROL test.

18. The process of claim 17 wherein clear coat is cured with a tin catalyst.

19. The process of claim 17 wherein the aircraft's aerodynamic surfaces are first coated with a primer and then the clear coat.

20. The process of claim 17 wherein the aircraft's aerodynamic surfaces are first coated with a primer, second with pigmented paint, and then with the clear coat.
